(19) United States
(12) Patent Application Publication
(10) Pub. No.: US 2024/0412500 A1
(43) Pub. Date: Dec. 12, 2024

(54) LEARNING APPARATUS, PREDICTION APPRARATUS, AND IMAGING APPRARATUS

(71) Applicant: NIKON CORPORATION, Tokyo (JP)

(72) Inventors: Hidehisa TAKASAKI, Shanghai (CN); Norimitsu ANADA, Koga-shi (JP); Katsuki OHATA, Zuerich (CH); Kazuhiro ABE, Yokohama-shi (JP); Yosuke OTSUBO, Tokyo (JP); Yuuya TAKAYAMA, Foster City, CA (US)

(73) Assignee: NIKON CORPORATION, Tokyo (JP)

(21) Appl. No.: 18/578,967

(22) PCT Filed: Jul. 4, 2022
(86) PCT No.: PCT/JP2022/026634

§ 371 Date: Aug. 21, 2024

(30) Foreign Application Priority Data
Jul. 15, 2021 (JP) 2021-116884

(51) Int. Cl. G06V 10/82; G06Q 30/0202; G06T 7/00; G06T 7/60; G06T 7/70; G06V 10/40; G06V 40/16

(52) U.S. Cl. CPC G06V 10/82; G06Q 30/0202; G06T 7/0002; G06T 7/60; G06T 7/70; G06V 10/40; G06T 2207/20081; G06T 2207/30168; G06T 2207/30196; G06V 40/161

(57) ABSTRACT

A learning apparatus includes a processor that executes a program; and a storage device that stores the program, wherein the processor is configured to execute an acquisition process of acquiring an image data group, and correct data pertaining to sale of each piece of image data in the image data group; and a generation process of generating a learning model that predicts an ease of selling the image data on the basis of the image data group and the correct data acquired during the acquisition process.

### CLAIM OF PRIORITY

The present application claims priority from Japanese patent application No. 2021-116884 filed on Jul. 15, 2021, the content of which is hereby incorporated by reference into this application.

### TECHNICAL FIELD

The present invention relates to a learning apparatus, a prediction apparatus, and an imaging apparatus.

### BACKGROUND ART

A technique of extracting a plurality of candidate images from a video capturing a subject and selecting an image by calculating evaluation values of the images on the basis of determination results for the orientation of the face of the person in the image is known.

### RELATED ART DOCUMENTS

### Patent Documents

Patent Document 1: JP 2004-361989 A

### SUMMARY

An aspect of the disclosure of a learning apparatus includes a processor that executes a program; and a storage device that stores the program, wherein the processor is configured to execute an acquisition process of acquiring an image data group, and correct data pertaining to sale of each piece of image data in the image data group; and a generation process of generating a learning model that predicts an ease of selling the image data on the basis of the image data group and the correct data acquired during the acquisition process.

Another aspect of the disclosure of a learning apparatus includes a processor that executes a program and a storage device that stores the program, wherein the processor is configured to execute an acquisition process of acquiring correct data pertaining to sale of an image data group from a server as a result of transmitting the image data group to the server; and a generation process of generating a learning model that predicts an ease of selling the image data on the basis of the image data group and the correct data acquired during the acquisition process.

An aspect of the disclosure of a prediction apparatus includes a processor that executes a program and a storage device that stores the program, wherein the processor is configured to execute an acquisition process of acquiring to-be-predicted image data; and a prediction process of inputting the to-be-predicted image data acquired during the acquisition process to a learning model that predicts an ease of selling image data, thereby generating a score indicating the ease of selling the to-be-predicted image data.

An aspect of the disclosure of a prediction apparatus includes a processor that executes a program; and a storage device that stores the program, wherein the processor is configured to execute an acquisition process of acquiring a learning model that predicts an ease of selling the image data and a prediction process of inputting to-be-predicted image data to the learning model acquired by the acquisition process, thereby generating a score indicating the ease of selling the to-be-predicted image data.

### BRIEF DESCRIPTION OF THE DRAWINGS

FIG. 1 is a descriptive view showing a system configuration example of a selling ease analysis system.

FIG. 2 is a block diagram for showing a hardware configuration example of the server 101.

FIG. 3 is a block diagram for showing a hardware configuration example of an electronic device.

FIG. 4 is a sequence view showing a learning model generation sequence example 1 performed by the selling ease analysis system.

FIG. 5 is a descriptive view showing an example of the image feature data table.

FIG. 6 is a descriptive view showing an example of a subject score table.

FIG. 7 is a descriptive view showing a subject score calculation example 1.

FIG. 8 is a descriptive view showing a score calculation example 2.

FIG. 9 is a descriptive view showing an example of the sale page information table.

FIG. 10 is a descriptive view showing an example of a sale page.

FIG. 11 is a descriptive view showing an example of a correct data management table.

FIG. 12 is a flowchart showing an example of detailed process steps of the correct data update process (step S406) shown in FIG. 4.

FIG. 13 is a sequence view showing a learning model generation sequence example 2 performed by the selling ease analysis system.

FIG. 14 is a sequence view showing a learning model generation sequence example 3 performed by the selling ease analysis system.

### DETAILED DESCRIPTION OF EMBODIMENTS

### Embodiment 1

### <System Configuration Example for Selling Ease Analysis System>

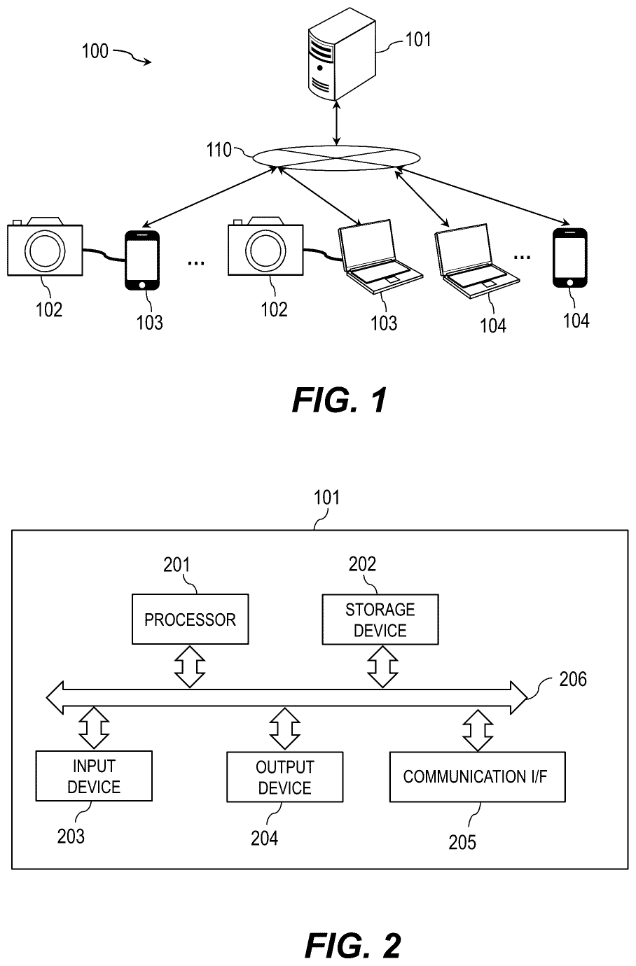

FIG. 1 is a descriptive view showing a system configuration example of a selling ease analysis system. A selling ease analysis system 100 includes a server 101, an imaging device 102 of a photographer/videographer, a communication terminal 103 of the photographer/videographer, and a communication terminal 104 of a user. The foregoing devices are in a wired or wireless connection in a manner enabling communication therebetween via a network 110 such as the internet, a LAN (local area network), or a WAN (wide area network). The communication terminals 103 and 104 are personal computers or smartphones, for example.

The server 101 learns the ease of selling image data and predicts the ease of selling the image data according to a learning model obtained by learning. The ease of selling is an index value indicating the sale prospects for image data, and specifically, is the number of times that the image data was viewed by users at a sale page of the server 101, the viewing time, the number of times that users selected the image data for purchase (how large the add-to-cart count is), the number of times that users decided to remove the image data from consideration for purchase (how small the removal-from-cart count is), the sold unit count, or a weighted linear sum of the foregoing.

The server 101 also functions as an electronic commerce (e-commerce) site for selling the image data. In Embodiment 1, the server 101 has three functions including the functions of learning and predicting the ease of selling the image data as well as the function of selling the image data, but alternatively, a plurality of servers 101, each of which has at least one function, may be provided.

The imaging device 102 is an imaging apparatus used by a photographer/videographer to perform imaging, and generates image data by capturing a subject. The imaging device 102 is a camera, for example. The communication terminal 103 of the photographer/videographer can connect to the imaging device 102, acquires image data generated by the imaging device 102, and transfers the image data to the server 101. The communication terminal 103 of the photographer/videographer can also perform imaging, and the communication terminal 103 of the photographer/videographer can transmit to the server 101 the image data generated by the communication terminal 103 of the photographer/videographer performing imaging. If the imaging device 102 has a communication function, the image data may be transferred directly to the server 101 without passing through the communication terminal 103.

The communication terminal 104 of the user can access the server 101 and purchase the image data. The communication terminal 103 of the photographer/videographer can also access the server 101 and purchase the image data.

### <Hardware Configuration Example>

FIG. 2 is a block diagram for showing a hardware configuration example of the server 101. The server 101 has a processor 201, a storage device 202, an input device 203, an output device 204, and a communication interface (communication I/F) 205. The processor 201, the storage device 202, the input device 203, the output device 204, and the communication I/F 205 are connected by a bus 206. The processor 201 controls the server 101. The storage device 202 is the work area of the processor 201. Also, the storage device 202 is a non-transitory or transitory recording medium that stores various programs and data. Examples of such a storage device 202 include, for example, ROM (read only memory), RAM (random access memory), an HDD (hard disk drive), or a flash memory. The input device 203 is for inputting data. Examples of the input device 203 include a keyboard, a mouse, a touch panel, a numeric keypad, a scanner, and a microphone. The output device 204 is for outputting data. Examples of the output device 204 include a display, a printer, and a speaker. The communication I/F 205 connects to the network 110 and transmits/receives data.

### <Hardware Configuration Example of Imaging Device 102 and Communication Terminals 103, 104 (Hereinafter Collectively Referred to as Electronic Device 300)>

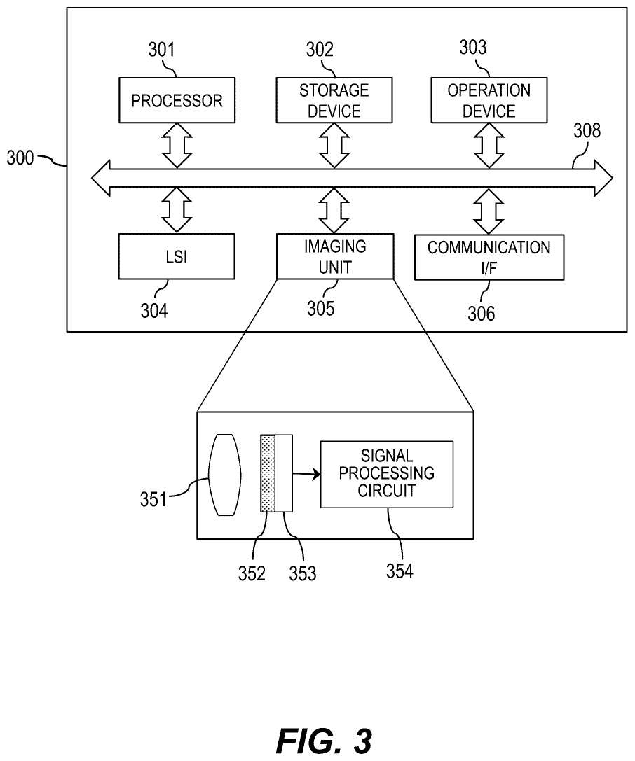

FIG. 3 is a block diagram for showing a hardware configuration example of an electronic device 300. The electronic device 300 has a processor 301, a storage device 302, an operation device 303, an LSI (large-scale integration) 304, an imaging unit 305, and a communication interface (I/F) 306. These are connected by a bus 308. The processor 301 controls the electronic device 300. The storage device 302 is the work area of the processor 301.

The storage device 302 is a non-transitory or transitory recording medium that stores various programs and data. Examples of such a storage device 302 include, for example, ROM (read only memory), RAM (random access memory), an HDD (hard disk drive), or a flash memory. Examples of the operation device 303 include a button, a switch, and a touch panel.

The LSI 304 is an integrated circuit that executes specific processes including image processes such as color interpolation, contour enhancement, and gamma correction; an encoding process; a decoding process; a compression/decompression process; and the like.

The imaging unit 305 captures a subject and generates JPEG image data or RAW image data, for example. The imaging unit 305 has an imaging optical system 351, an imaging element 353 having color filters 352, and a signal processing circuit 354.

The imaging optical system 351 is constituted of a plurality of lenses including a zoom lens and a focus lens, for example. For a simplified view, in FIG. 3, one lens is depicted for the imaging optical system 351.

The imaging element 353 is a device for capturing an image of a subject using light beams passing through the imaging optical system 351. The imaging element 353 may be a sequential scanning type solid-state image sensor (such as a CCD (charge-coupled device) image sensor), or may be an X-Y addressing type solid-state imaging element (such as a CMOS (complementary metal-oxide semiconductor) image sensor).

On the light-receiving surface of the imaging element 353, pixels having photoelectric conversion units are arranged in a matrix. For each pixel of the imaging element 353, a plurality of types of color filters 352 that respectively allow through light of differing color components are arranged in a prescribed color array. Thus, each pixel of the imaging element 353 outputs an electrical signal corresponding to each color component as a result of color separation by the color filter 352.

The signal processing circuit 354 sequentially executes, on an image signal inputted from the imaging element 353, an analog signal process (correlated double sampling, black level correction, etc.), an A/D conversion process, and digital signal processing (defective pixel correction). The JPEG image data or RAW image data outputted from the signal processing circuit 354 is inputted to the LSI 304 or the storage device 302. The communication I/F 306 connects to an external device via the network 110 and transmits/receives data.

### <Learning Model Generation Sequence Example 1>

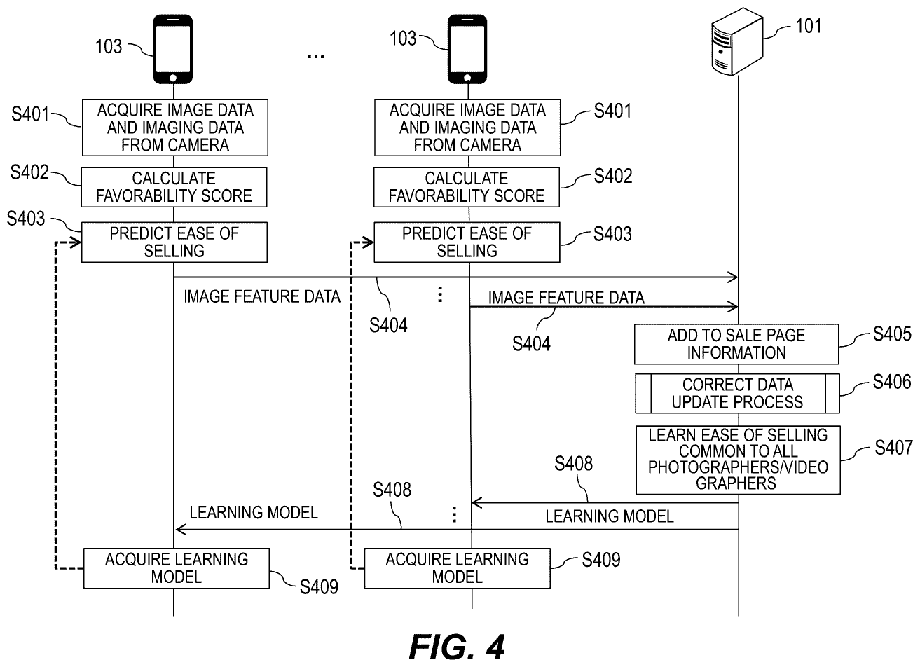

FIG. 4 is a sequence view showing a learning model generation sequence example 1 performed by the selling ease analysis system 100. FIG. 4 shows an example in which the server 101 executes learning and prediction of the ease of selling image data generated by the imaging device 102, but the server 101 may execute learning and prediction of the ease of selling the image data generated by the imaging device 102 or the communication terminal 103 of the photographer/videographer.

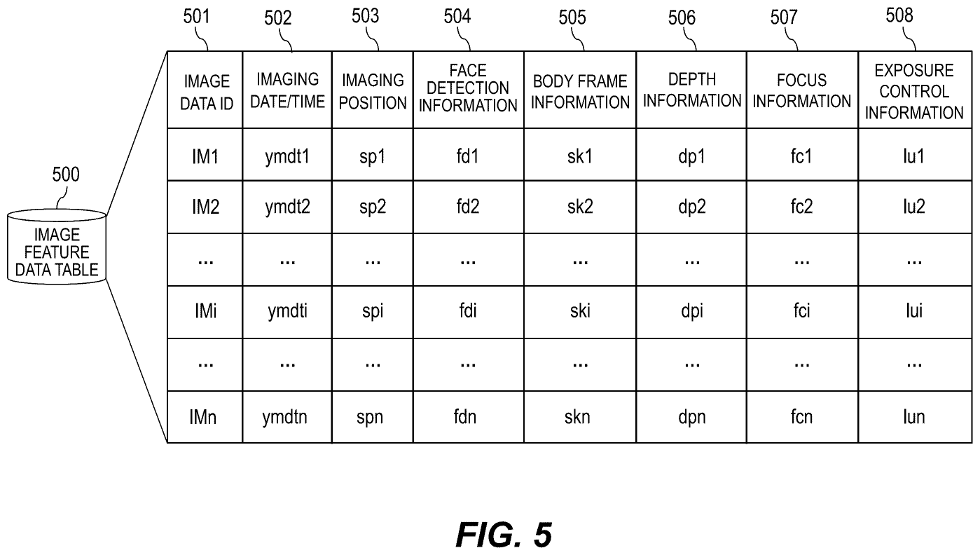

The communication terminal 103 of the photographer/videographer acquires image data and imaging data from the imaging device 102 to which the communication terminal 103 is connected, and stores the same in an image feature data table 500 shown in FIG. 5 (step S401). Here, the image data is image feature data indicating a pixel data group generated by imaging performed by the imaging device 102.

The imaging data is image feature data including the imaging date/time and imaging location of the image data, face detection information or body frame information of the subject acquired from the image data, and at least one among the depth information, focus information, and exposure control information at the time of imaging, acquired from the imaging device 102. Such information acquired from the imaging device 102 is merely one example, and aside therefrom, various information such as information pertaining to the imaging scene, color temperature information, and audio information may be included. Below, the image feature data will be described in detail with reference to FIG. 5.

### [Image Feature Data Table 500]

FIG. 5 is a descriptive view showing an example of the image feature data table 500. The image feature data table 500 is stored in the storage device 302 of the communication terminal 103 of the photographer/videographer. The image feature data table 500 has as fields an image data ID 501, an imaging date/time 502, an imaging location 503, face detection information 504, body frame information 505, depth information 506, focus information 507, and exposure control information 508, for example.

The image data ID 501 is identification information that uniquely identifies the image data. The image data ID 501 is a pointer for accessing the image data stored in the storage device 302. The image data with a value IMi for the image data ID 501 is recorded as image data IMi.

The imaging date/time 502 is the date and time at which the image data IMi was generated by imaging performed by the imaging device 102. The imaging location 503 is latitude/longitude information at which the image data IMi was captured. If the imaging device 102 has a positioning function for the current location, then the latitude/longitude information attained at the imaging date/time 502 is set as the imaging location 503. If a wireless LAN module is installed on the imaging device 102, then the latitude/longitude information of the access point to which the imaging device 102 was connected at the imaging date/time 502 is set as the imaging location 503.

If the communication terminal 103 of the photographer/videographer has a positioning function for the current location, then the latitude/longitude information attained by the communication terminal 103 of the photographer/videographer during the same time period as the imaging date/time 502 of the image data IMi is set as the imaging location 503. If a wireless LAN module is installed on the imaging communication terminal 103 of the photographer/videographer, then the latitude/longitude information of the access point to which the communication terminal 103 of the photographer/videographer was connected during the same time period as the imaging date/time 502 of the image data IMi is set as the imaging location 503.

The face detection information 504 includes the number of facial images detected in the image data IMi as well as the positions of the faces in the image data and the facial expressions. The body frame information 505 is information indicating the body frame of the subject for whom a face was detected, and is a combination of nodes that serve as body frame points and links that connect the nodes. The depth information 506 is a depth map (may alternatively be a defocus map) of a prescribed number of through images prior to imaging performed by the imaging device 102.

The focus information 507 is information pertaining to the position and focus state of a ranging point in the image data IMi. The exposure control information 508 is a combination of the aperture, shutter speed, and ISO speed determined by an exposure control mode (e.g., program auto, shutter speed priority auto, aperture priority auto, manual exposure) at the time of imaging performed by the imaging device 102. A white balance setting mode (auto, daylight, tungsten, etc.) may be included. The color temperature information 507 is the color temperature of the image data. If information pertaining to an imaging scene is included in the imaging data, then the imaging scene such as an event (marathon, wedding, etc.) may be identified through automatic recognition according to objects included in the image data, for example.

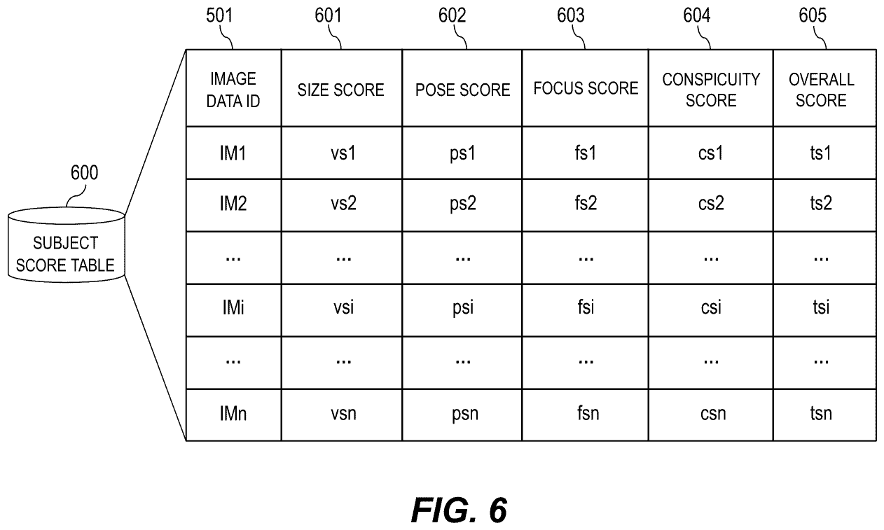

In FIG. 4, the communication terminal 103 of the photographer/videographer calculates subject scores indicating the favorability of the image data IMi, and stores the subject scores in a subject score table 600 shown in FIG. 6 (step S402). Specifically, the subject scores include a score pertaining to the size of the subject (size score), a score pertaining to the pose of the subject (pose score), a score indicating the degree of focus of the subject (focus score), a score indicating the degrees of conspicuity among subjects (conspicuity score), and an overall score including all of the foregoing. The subject scores are also image feature data.

### [Example of Subject Score Table 600]

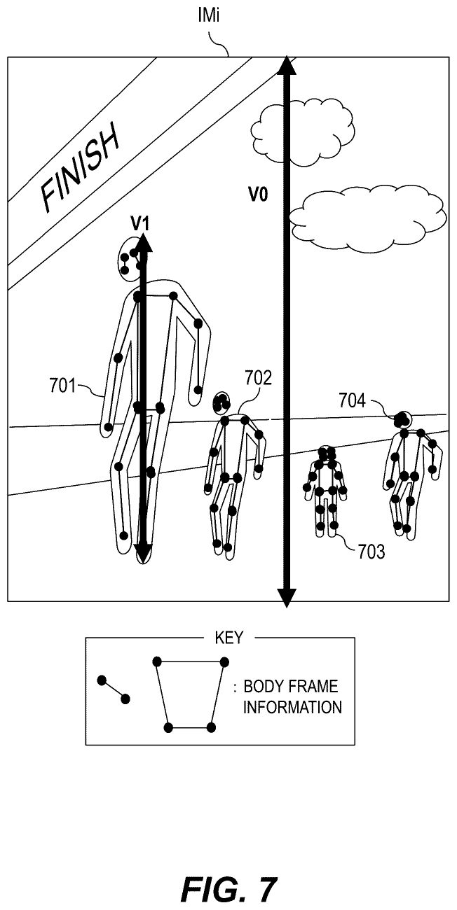

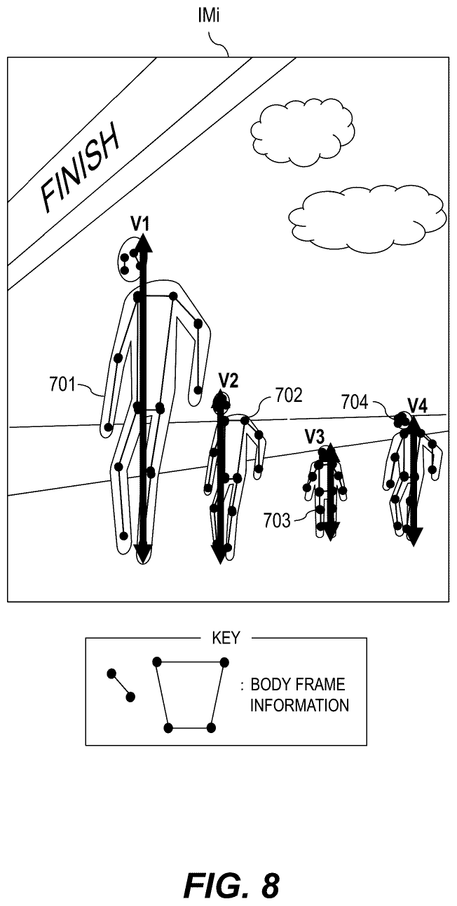

FIG. 6 is a descriptive view showing an example of a subject score table 600. The subject score table 600 is a table storing the subject score for each piece of image data IMi. The subject score table 600 has as fields the image data ID 501, a size score 601, a pose score 602, a focus score 603, a conspicuity score 604, and an overall score 605. The size score 601, the pose score 602, and the focus score 603 will be described with reference to FIG. 7, and the conspicuity score 604 will be described with reference to FIG. 8. The overall score 605 may be a total of the size score 601, the pose score 602, the focus score 603, and the conspicuity score 604, may be a prescribed weighted linear sum, or may be an average thereof.

FIG. 7 is a descriptive view showing a subject score calculation example 1. The size score 601 is a ratio V1/V0, where a width V1 in the vertical direction of a human subject 701 identified by the face detection information 504 and the body frame information 505 is divided by a width V0 in the vertical direction of the background of the image data IMi. The size score 601 is also calculated for other human subjects 702 to 704.

The pose score 602 is a score calculated for each of the human subjects 701 to 704 on the basis of the body frame information 505 of the subjects 701 to 704 identified according to the face detection information 504 and the body frame information 505. Specifically, the pose score 602 increases the higher the positions of the hands of the subjects 701 to 704 are in the vertical direction, and also increases the further apart both hands of each of the subjects are if both hands appear in the image. The pose score 602 would be the highest in a state where the subject has both arms raised all the way up, for example.

The focus score 603 is a score calculated for each of the human subjects 701 to 704 on the basis of the face detection information 504, the depth information 506, and the focus information 507 of the subjects 701 to 704 identified according to the face detection information 504 and the body frame information 505. Specifically, the focus score 603 is higher, the greater the degree to which the area of the face of the subject near the eyes is in focus, for example.

FIG. 8 is a descriptive view showing a score calculation example 2. The conspicuity score 604 is a score indicating the relative sizes of the subjects 701 to 704 on the basis of the vertical widths V1 to V4 of the subjects 701 to 704. Specifically, for the image data IMi, a value csi of the conspicuity score 604 is calculated by the following formula, for example.

$$csi = V \# / ( V 1 + V 2 + V 3 + V 4 )$$

Here, “#” indicates any value of 1 to 4.

Thus, in the image data IMi, the size score 601, the pose score 602, the focus score 603, the conspicuity score 604, and the overall score 605 are calculated as subject scores for each of the subjects 701 to 704. The calculation methods for the scores pertaining to the size, pose, focus, and conspicuity of the subject may be modified according to the imaging scene. If the imaging scene is the finish line of a marathon, for example, then it is possible to provide a high pose score for image data including poses where both arms of the subject extend out in the horizontal direction. As an alternative to focusing on features of each of the subjects, in a case where a plurality of subjects are included in one piece of image data, a score can be provided with focus on the overall balance such as the relative positions of the subjects and the degree of scattering of the subjects.

In FIG. 4, the communication terminal 103 of the photographer/videographer predicts the ease of selling the image data IMi for which a prediction is to be made (step S403). Specifically, if the learning model has been acquired (step S409), the communication terminal 103 of the photographer/videographer inputs the image feature data of the image data IMi subject to prediction to the learning model in order to predict the ease of selling.

Specifically, the image feature data of the image data IMi subject to prediction that is inputted to the learning model should be at least one of the image data IMi, imaging data pertaining to the image data IMi, and the subject score, for example. If the imaging data is inputted to the learning model, then at least one of the face detection information 504, the body frame information 505, the depth information 506, the focus information 507, and the exposure control information 508 should be included as the imaging data for the image data IMi. The imaging date/time 502 and the imaging location 503 are used as information defining the type of learning model as opposed to data inputted to the learning model.

Also, if the subject scores are inputted to the learning model, then subject scores inputted for the image data IMi should be at least one of the size score 601, the pose score 602, the focus score 603, and the conspicuity score 604, and the overall score 605. If the learning model is yet to be acquired by the communication terminal 103 of the photographer/videographer, then step S403 is not executed.

The photographer/videographer then refers to the size score 601, the pose score 602, the focus score 603, the conspicuity score 604, and the overall score 605 for each of the subjects 701 to 704 calculated for the image data IMi. The communication terminal 103 of the photographer/videographer determines the subject 701 to 704 of the image data IMi for which to the transmit the image feature data.

If a subject for whom the overall score 605 exceeds a threshold is present in the image data IMi, the communication terminal 103 of the photographer/videographer may set the image feature data of this subject to be transmitted. The communication terminal 103 of the photographer/videographer may delete image feature data for image data IMi in which no subject with an overall score 605 exceeding the threshold is present, for example. The communication terminal 103 of the photographer/videographer transmits, to the server 101, the image feature data that was set to be transmitted (step S404). The image feature data to be transmitted includes at least the image data IMi and the subject score. However, if the server 101 is to perform learning using the imaging data, then the imaging data is also included.

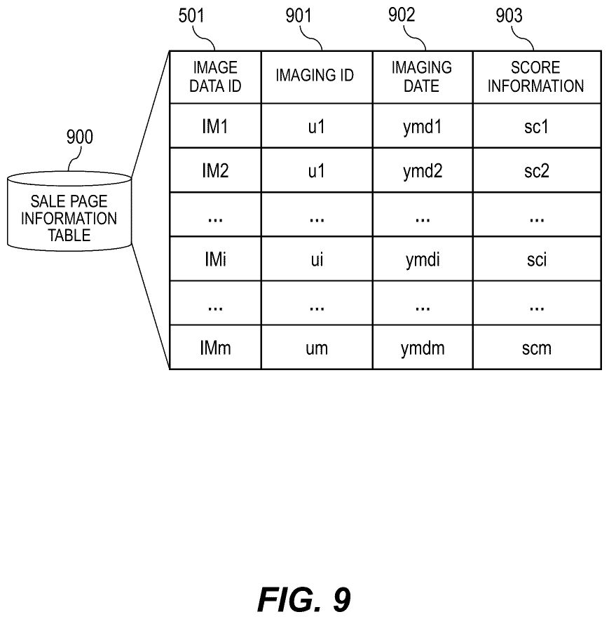

Upon receiving the image feature data, the server 101 stores the image feature data in the storage device 202, and adds sale page information to a sale page information table 900 shown in FIG. 9 (step S405). The sale page information is information used in a web page (sale page) that sells the image data IMi.

### [Sale Page Information]

FIG. 9 is a descriptive view showing an example of the sale page information table 900. The sale page information table 900 has, as fields, an imaging data ID 501, an imaging ID 901, an imaging date 902, and score information 903. The values of image data ID 501, the imaging ID 901, the imaging date 902, and the score information 903 belonging to the same row constitute the sale page information of the image data IMi.

The image data ID 501 is a pointer for accessing the image data IMi stored in the storage device 202. The photographer/videographer ID 901 is identification information that uniquely identifies the photographer/videographer or the imaging device 102, and is included in the image data IMi, for example. The imaging date 902 is the date at which the image data IMi was captured by the photographer/videographer using the imaging device 102, and is included in the image data IMi, for example. The score information 903 is the subject scores included in the image feature data transmitted from the communication terminal 103 of the photographer/videographer, or in other words, the size score 601, the pose score 602, the focus score 603, the conspicuity score 604, and the overall score 605.

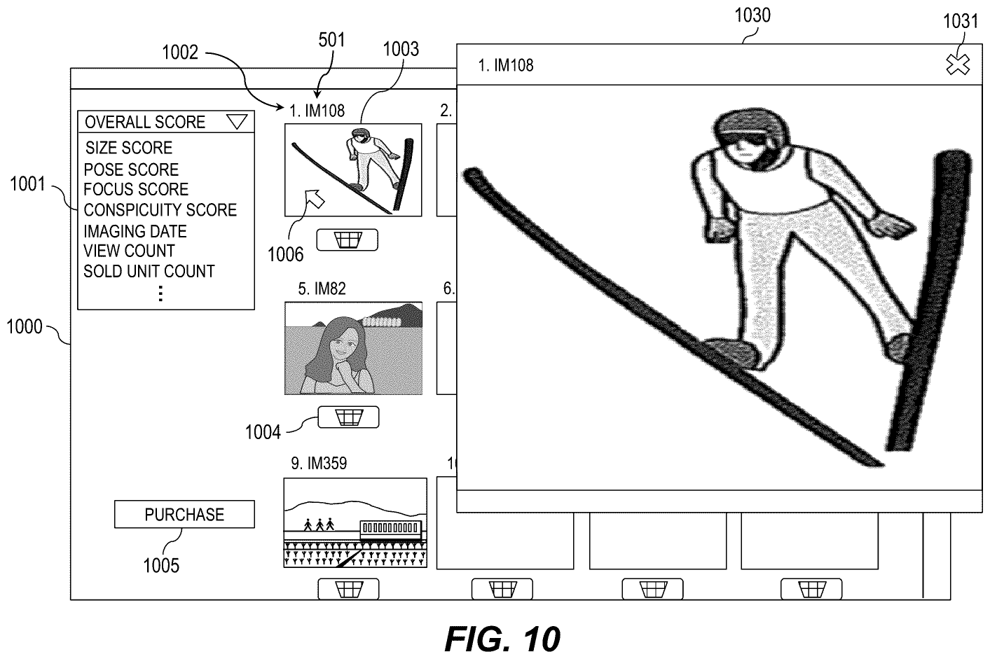

FIG. 10 is a descriptive view showing an example of a sale page. A sale page 1000 is stored in the server 101, and is displayed in the communication terminal 104 of the user when the communication terminal 104 of the user accesses the server 101. The sale page 1000 displays a display order type selection pull-down menu 1001, display ranks 1002, the image data IDs 501, thumbnails 1003, add-to-cart buttons 1004, and a purchase button 1005.

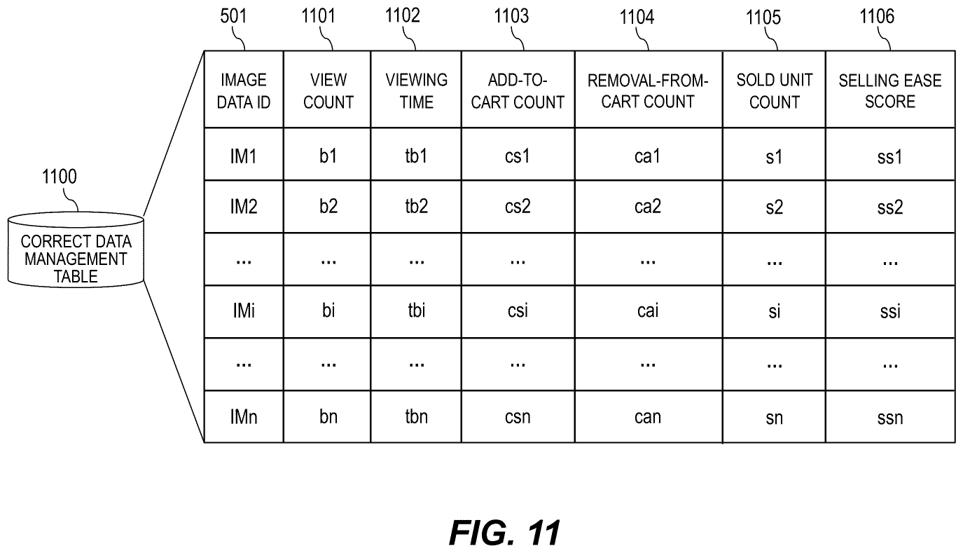

The display order type selection pull-down menu 1001 is a user interface for selecting the display order type of the thumbnails. The selectable display order types include options such as the size score 601, the pose score 602, the focus score 603, the conspicuity score 604, and the overall score 605, which are instances of score information 903, as well as the imaging date 902, a view count 1101, and a sold unit count 1105 (to be mentioned later with reference to FIG. 11). The options can be selected using a cursor 1006. FIG. 10 shows a state in which the overall score 605 is selected.

The display rank 1002 is the rank at which the thumbnail 1003 is displayed according to the option selected at the display order type selection pull-down menu 1001. The higher the display rank 1002 is, the higher the thumbnail is displayed on the sale page 1000. The image data ID 501 is displayed together with the display rank.

The thumbnail 1003 is a reduced-size version of the image data IMi. If the thumbnail 1003 is designated by being pressed by the cursor 1006, then an expanded version 1030 of the thumbnail 1003 (i.e., the image data IMi) is displayed, and the expanded version 1030 is removed by pressing an x button 1031 at the top right thereof. The display count for the expanded version 1030 is counted as the view count 1101 (to be mentioned later with reference to FIG. 11) of the image data IMi. The server 101 measures the time that the expanded version 1030 of the thumbnail 1003 is displayed as a view time 1102 (to be mentioned later with reference to FIG. 11).

The add-to-cart button 1004 is a button that, by being pressed, selects the image data IMi corresponding to the thumbnail 1003 for purchase. As a result of the add-to-cart button 1004 being pressed, the color thereof is also inverted. The number of times that the image data IMi is selected for purchase is counted as an add-to-cart count 1103 (to be mentioned later with reference to FIG. 11). As a result of the add-to-cart button 1004 being pressed again, the image data IMi is removed from the cart, or in other words, removed from consideration for purchase, and the add-to-cart button 1004 reverts to the original color. The number of times that the image data IMi is removed from consideration for purchase is counted as a removal-from-cart count 1104 (to be mentioned later with reference to FIG. 11).

The purchase button 1005 is a button that, by being pressed, causes the image data IMi selected for purchase to be purchased. When the purchase button 1005 is pressed, the website switches to a purchase screen (not shown), and the purchase of the image data IMi selected for purchase (i.e., the transaction) is completed. A purchase count 1105 for the image data IMi is counted as the sold unit count. The user can acquire a printed photograph of the purchased image data IMi by shipment from an operator of the server 101 or download the purchased image data IMi from the server 101 to the communication terminal 104 of the user. As an alternative to the method by which the purchase count 1105 is determined according to the number of instances that the add-to-cart button 1004 was pressed, the purchase count 1105 for the image data IMi may be determined by the user directly inputting the purchase count. At this time, the directly inputted purchase count can also be set as the add-to-cart count 1103.

In FIG. 4, the server 101 executes a correct data update process (step S406). The correct data update process (step S406) is a process of updating correct data. The correct data includes, for example, the view count 1101, the view time 1102, the add-to-cart count 1103, the removal-from-cart count 1104, and a selling ease score 1106 in addition to the sold unit count 1105 (purchase count by users).

### [Correct Data Management Table]

FIG. 11 is a descriptive view showing an example of a correct data management table. The correct data management table 1100 includes, as fields, the image data ID 501, the view count 1101, the view time 1102, the add-to-cart count 1103, the removal-from-cart count 1104, the sold unit count 1105, and the selling ease score 1106.

The view count 1101 is correct data indicating the number of times that the image data IMi is viewed, or in other words, the number of times that the expanded version 1030 of the thumbnail 1003 has been displayed. The view time 1102 is correct data indicating the length of time that the expanded version 1030 has been displayed. The add-to-cart count 1103 is correct data indicating the number of times that the image data IMi was selected for purchase by the pressing of the add-to-cart button 1004.

The removal-from-cart count 1104 is correct data indicating the number of times that the image data IMi was removed from consideration for purchase by a second pressing of the add-to-cart button 1004. Additionally, the closing of the sale page 1000 by pressing the x button 1031 in a state where the image data IMi is selected for purchase is also counted towards the removal-from-cart count 1104.

The sold unit count 1105 is correct data indicating the number of times that the image data IMi was purchased by users. If there are a plurality of purchasable sizes for the image data IMi, the sold unit count 1105 is counted for each purchasable size.

The selling ease score 1106 is correct data that is a numerical representation of the ease of selling the image data IMi, and here, the higher the value of the selling ease score 1106 is, the easier the image data IMi is to sell. Specifically, the selling ease score 1106 is represented by a regression formula of the weighted linear sum of the view count 1101, the view time 1102, the add-to-cart count 1103, the removal-from-cart count 1104, and the sold unit count 1105, for example.

The value of each weight in the regression formula can be freely set between 0 and 1, for example. As an example, the values of the weights for the view count 1101, the view time 1102, the add-to-cart count 1103, and the sold unit count 1105 can be set to 0.5 or greater, and the value of the weight for the removal-from-cart count 1104 can be set to less than 0.5. The selling ease score 1106 may alternatively be a correct label set to “popular image” if the calculation result of the regression formula is greater than or equal to a threshold, and “unpopular image” if the result is less than the threshold.

The selling ease score 1106 can be set as any one of the view count 1101, the view time 1102, the add-to-cart count 1103, the removal-from-cart count 1104, and the sold unit count 1105, or can be represented by a regression formula of a simple sum or a weighted linear sum by combining the foregoing elements as needed. A normalization method may be used for matching the dimensions of the elements. In this case, the normalized elements may be weighted and represented by a regression formula of a simple sum or a weighted linear sum.

The combination of the image feature data and the selling ease score 1106 that is the correct data for each piece of image data IMi is a learning data set, and is used for generating the learning model. The view count 1101, the view time 1102, the add-to-cart count 1103, the removal-from-cart count 1104, and the sold unit count 1105 are actual measured values, and thus, the correct data management table 1100 is updated every time measurement is performed. If, for example, a plurality of users are using the communication terminals 104, information such as the view count 1101 of each user is transmitted to the server, and the correct data management table 110 is updated every time the information is transmitted.

By contrast, the selling ease score 1106 is a value calculated according to the actual measured values. Thus, after generating the learning model, the server 101 inputs the corresponding image feature data and selling ease score 1106 to the learning model, thereby causing relearning by the learning model and allowing for an improvement in prediction accuracy for the ease of selling. The server 101 may calculate the selling ease score 1106 by inputting to the learning model the corresponding image feature data and the selling ease score 1106, and update the selling ease score 1106 of the correct data management table 1100 with the calculated value. The correct data update process (step S406) is described later.

In FIG. 4, the server 101 uses the learning data set to learn the ease of selling common to all photographers/videographers (step S407). The image feature data used for learning should be at least one of the image data IMi, imaging data pertaining to the image data IMi, and the subject score. If the imaging data is used for learning, then at least one of the face detection information 504, the body frame information 505, the depth information 506, the focus information 507, and the exposure control information 508 should be included as the imaging data for the image data IMi.

Also, if the subject scores are inputted to the learning model, then subject scores inputted for the image data IMi should be at least one of the size score 601, the pose score 602, the focus score 603, and the conspicuity score 604, and the overall score 605.

The server 101 determines a weight parameter and a bias for a neural network through backpropagation such that a loss function based on the sum of squares of the difference between the prediction value of the selling ease score 1106 and the correct data (value of the selling ease score 1106 in the correct data management table 1100) is at a minimum. As a result, a learning model for which the weight parameter and the bias are set for the neural network is generated. Also, the server 101 may generate a learning model in which the learning models of at least two among the image data, the imaging data, and the subject score are ensembled.

Also, the server 101 may generate a learning model (fully-connected learning model) by generating learning models that have the view count 1101, the view time 1102, the add-to-cart count 1103, the removal-from-cart count 1104, and the sold unit count 1105 respectively as correct data, and fully connecting the learning models. In such a case, the correct data of the fully-connected learning model is the selling ease score 1106.

Also, the server 101 may classify the image data IMi on the basis of the imaging date/time 502 and/or the imaging location 503, and generate a learning model for each of the classified image data groups. Specifically, if the server 101 aggregates an image data group where the imaging date/time 502 is during the night and the exposure control information 508 is in night mode (may be a histogram indicating night scene characteristics), then a learning model pertaining to a night scene can be generated, for example.

If the server 101 can access map information on the network 110 and the imaging location 503 is at the latitude/longitude information indicating a theme park, then if an image data group thereof is aggregated, a learning model pertaining to the theme park can be generated.

If the server 101 can access map information and event information on the network 110, the imaging location 503 is at the latitude/longitude information indicating the Koshien Stadium, and the imaging date/time 502 indicates a period during the Japanese High School Baseball Championship, then if an image data group thereof is aggregated, a learning model pertaining to the Japanese High School Baseball Championship can be generated.

The server 101 transmits the learning model generated in step S407 to the communication terminal 103 of the photographer/videographer (step S408). If a neural network is present in the communication terminal 103 of the photographer/videographer, the server 101 may transmit learning parameters (weight parameters and bias). As a result, the communication terminal 103 of the photographer/videographer can generate a learning model by setting the received learning parameters to the neural network.

The communication terminal 103 of the photographer/videographer acquires the learning model transmitted from the server 101 (step S409). Thus, when the communication terminal 103 of the photographer/videographer newly acquires image feature data, by inputting the image feature data to the learning model, it is possible to predict the selling ease score 1106.

Then, the communication terminal 103 of the photographer/videographer uses the learning model to predict the selling ease score 1106 for the image data IMi every time the image data IMi is newly acquired (step S403). After acquiring the learning model (step S409), the communication terminal 103 of the photographer/videographer may determine whether the predicted value of the selling ease score 1106 in step S403 exceeds a prescribed threshold instead of the subject score calculated in step S402.

If the predicted value of the selling ease score 1106 exceeds the prescribed threshold, then the communication terminal 103 of the photographer/videographer transmits the image feature data to the server 101 (step S404), and if the predicted value is less than or equal to the threshold, then the communication terminal 103 of the photographer/videographer deletes the image feature data. As a result, it is possible for the learning model to perform relearning with image feature data where the predicted value for the selling ease score 1106 exceeds the prescribed threshold. Thus, the prediction accuracy by the learning model for the ease of selling the image data is improved.

An object that indicates a high score can be displayed with image data where the predicted value of the selling ease score 1106 exceeds the prescribed threshold. By displaying a circle symbol to image data with a high score, for example, the user can confirm, with priority, images with the circle symbol displayed therewith, thereby enabling efficient selection of good images.

If, in step S408, the image feature data is acquired from the communication terminal 103 of the photographer/videographer without transmitting the learning model to the communication terminal 103 of the photographer/videographer, then the server 101 may input the acquired image feature data to the learning model to predict the selling ease score 1106, and transmit the predicted value for the selling ease score 1106 to the communication terminal 103 of the photographer/videographer from which the image feature data was transmitted. As a result, the server 101 need not transmit the learning model to the communication terminal 103 of the photographer/videographer every time the learning model is updated, thereby enabling a decrease in the transmission load.

### <Correct Data Update Process (Step S406)>

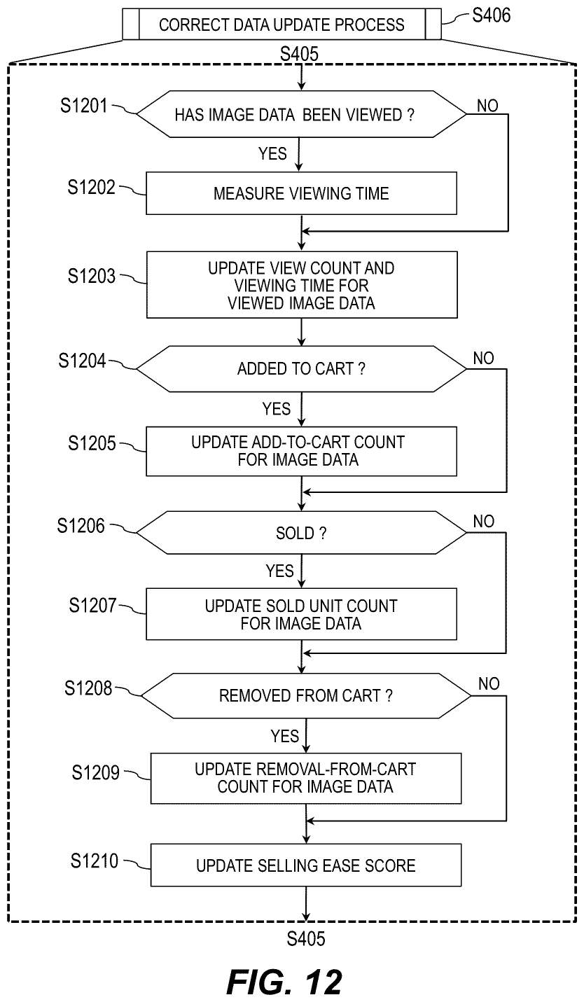

FIG. 12 is a flowchart showing an example of detailed process steps of the correct data update process (step S406) shown in FIG. 4. The correct data update process (step S406) is executed for each piece of image data IMi at each detection performed for steps S1201, S1204, S1206, and S1208 through the transmission and reception performed with the communication terminal 104 of the user, for example.

The server 101 determines whether the image data IMi has been viewed by the communication terminals 104 of the users (step S1201). Specifically, the server 101 determines whether the thumbnail 1003 was pressed in the communication terminal 104 of the user and the expanded version 1030 of the thumbnail 1003 was displayed. If the image data IMi was not viewed (step S1201: No), then the process progresses to step S1203.

On the other hand, if the image data IMi has been viewed (step S1201: Yes), then the server 101 measures the view time 1102 until viewing is ended (step S1202). Specifically, the server 101 measures the view time 1102 until receipt of a signal indicating that, in the communication terminal 104 of the user, the expanded version 1030 of the thumbnail 1003 was closed by the pressing of the x button 1031, for example.

The measurement of the view time 1102 may alternatively be executed in the communication terminal 104 of the user. In this case, the communication terminal 104 of the user transmits the measured view time 1102 to the server 101. The server 101 updates the view count 1101 and the view time 1102 of the correct data management table 1100 for the viewed image data IMi (step S1203).

Next, the server 101 determines whether there is image data IMi added to the cart (step S1204). Specifically, the server 101 determines whether there is image data IMi selected for purchase by the pressing of the add-to-cart button 1004 in the communication terminal 104 of the user, for example. If there is no image data IMi added to the cart (step S1204: No), then the process progresses to step S1206.

On the other hand, if there is image data IMi added to the cart (step S1204: Yes), the server 101 updates the add-to-cart count 1103 of the correct data management table 1100 for the image data IMi (step S1203).

Next, the server 101 determines whether the image data IMi added to the cart has been sold (step S1206). Specifically, the server 101 determines whether the purchase button 1005 was pressed in a state where there is image data IMi selected for purchase in the communication terminal 104 of the user, thereby completing the transaction, for example. If there is no sold image data IMi (step S1206: No), then the process progresses to step S1208.

On the other hand, if there is sold image data IMi (step S1206: Yes), the server 101 updates the sold unit count 1105 of the correct data management table 1100 for the image data IMi (step S1203).

Next, the server 101 determines whether there is image data IMi removed from the cart (step S1208). Specifically, the server 101 determines whether there is image data IMi removed from consideration for purchase by a second pressing of the add-to-cart button 1004 in the communication terminal 104 of the user, for example. If there is no image data IMi removed from the cart (step S1208: No), then the process progresses to step S1210.

On the other hand, if there is image data IMi removed from the cart (step S1208: Yes), the server 101 updates the removal-from-cart count 1104 of the correct data management table 1100 for the image data IMi (step S1209).

Next, the server 101 updates the selling ease score 1106 (step S1210). Specifically, if the learning model is yet to be generated, for example, then the server 101 inputs, to the above-mentioned regression formula, the view count 1101, the view time 1102, the add-to-cart count 1103, the removal-from-cart count 1104, and the sold unit count 1105 of the updated latest entry for the image data IMi in the correct data management table 1100, thereby calculating and updating the selling ease score 1106. If the learning model has been generated, then the server 101 does not execute step S1210 and relearns the learning model in step S407.

In this manner, according to Embodiment 1, it is possible to predict the ease of selling the image data IMi, and it is possible to upload the image data IMi anticipated to be sold, to the server 101 from the communication terminal 103 of the photographer/videographer. Also, by calculating the subject score indicating the favorability of the image data IMi in the communication terminal 103 of the photographer/videographer prior to upload (step S402), the photographer/videographer can objectively evaluate the image data IMi.

Specifically, the photographer/videographer can compare the selling ease score 1106 to the subject scores and identify which subject score is a factor in whether or not the image data IMi is popular, for example. As a result, the photographer/videographer can upload the image data IMi to the server 101 or avoid unnecessary uploads of the image data IMi according to the selling ease score 1106.

If the operator of the server 101 takes payment based on the length of time that the image data IMi is posted on the sale page 1000 from the photographer/videographer, then the photographer/videographer can mitigate a decrease in profit by carefully selecting for upload image data IMi that is expected to be popular.

From the perspective of the server 101, by reducing the number of posts of unpopular image data IMi on the sale page 1000, wasted view time by users is mitigated, encouraging sales and decreasing the load on the server 101.

In the example above, the selling ease score 1106 was used as the correct data, but any one of the view count 1101, the view time 1102, the add-to-cart count 1103, the removal-from-cart count 1104, and the sold unit count 1105 may be used as the correct data. As a result, a learning model that predicts any one of the view count 1101, the view time 1102, the add-to-cart count 1103, the removal-from-cart count 1104, and the sold unit count 1105 is generated.

### Embodiment 2

Next, Embodiment 2 will be described. In Embodiment 1, an example was described in which the server 101 generates a learning model common to all photographers/videographers. In Embodiment 2, an example will be described in which the server 101 generates a unique learning model for each of the photographers/videographers. In Embodiment 2, only differences from Embodiment 1 will be described, and the same components and same processes as those of Embodiment 1 are assigned the same reference characters and descriptions thereof are omitted.

### <Learning Model Generation Sequence Example 2>

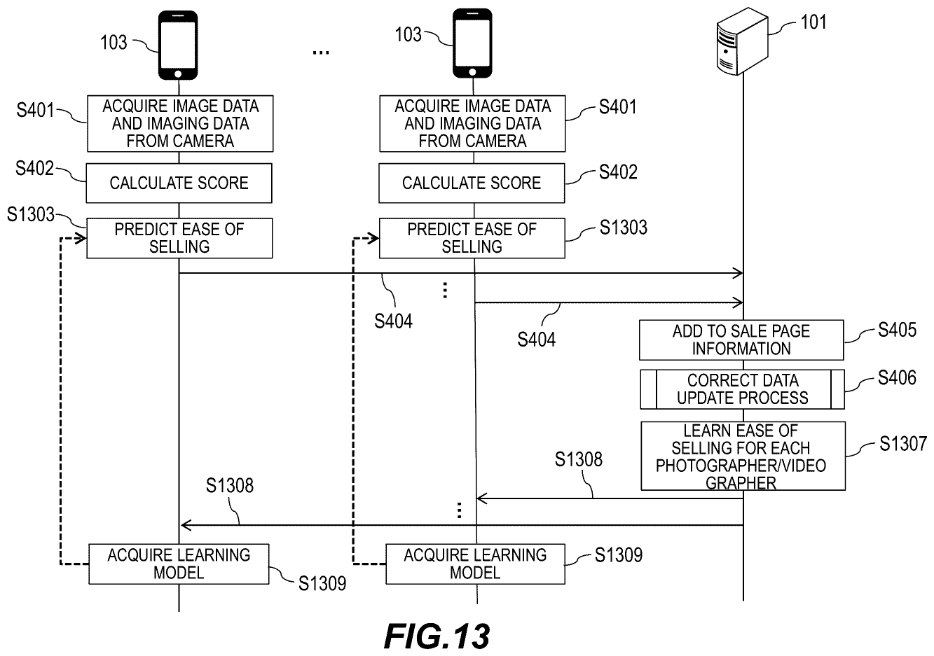

FIG. 13 is a sequence view showing a learning model generation sequence example 2 performed by the selling ease analysis system 100. In FIG. 13, the server 101 learns the ease of selling for each photographer/videographer (step S1307) after the correct data update process (step S406). That is, the server 101 generates a learning model for each photographer/videographer using the image feature data and the correct data for the image data IMi of the photographer/videographer.

Each of the communication terminals 103 of the photographers/videographers acquires the learning model generated individually (step S1309). Thus, each of the communication terminals 103 of the photographers/videographers predicts the ease of selling by the learning model unique to the photographer/videographer every time the image data IMi is newly acquired (step S1303). As a result, the photographer/videographer can predict the ease of selling using a learning model customized for the image data IMi captured by said photographer/videographer, and it is possible to upload efficiently the image data IMi anticipated to be sold, to the server 101 from the communication terminal 103 of the photographer/videographer.

If a neural network is present in the communication terminal 103 of the photographer/videographer, the server 101 may transmit learning parameters (weight parameters and bias) for each photographer/videographer to the communication terminal 103 of the photographer/videographer.

If the image feature data is acquired from the communication terminal 103 of the photographer/videographer without transmitting each learning model to the communication terminal 103 of each photographer/videographer, then the server 101 may input the acquired image feature data to the learning model of the photographer/videographer to predict the selling ease, and transmit the prediction result to the communication terminal 103 of the photographer/videographer from which the image feature data was transmitted. As a result, the server 101 need not transmit the learning model to the communication terminal 103 of the photographer/videographer every time the learning model is updated, thereby enabling a decrease in the transmission load. The server 101 may acquire the subject score alone as the image feature data from the communication terminal 103 of the photographer/videographer. In such a case, the communication terminal 103 no longer needs to transmit the image data including pixel data to the server 101, enabling a reduction in transmission load.

### Embodiment 3

Next, Embodiment 3 will be described. In Embodiment 2, an example was described in which the server 101 generates a unique learning model for each of the photographers/videographers. In Embodiment 3, an example will be described in which the communication terminal 103 of each photographer/videographer generates a unique learning model for each photographer/videographer. In Embodiment 3, only differences from Embodiments 1 and 2 will be described, and the same components and same processes as those of Embodiments 1 and 2 are assigned the same reference characters and descriptions thereof are omitted.

### <Learning Model Generation Sequence Example 3>

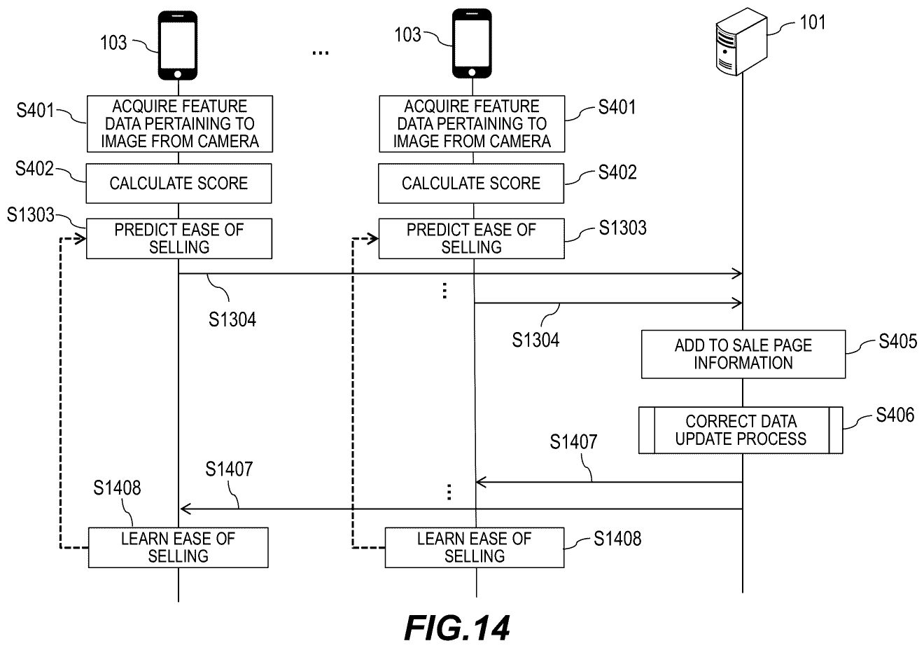

FIG. 14 is a sequence view showing a learning model generation sequence example 3 performed by the selling ease analysis system 100. In FIG. 14, the server 101 transmits the correct data (entry in the correct data management table 1100) for the image data IMi of the photographer/videographer to each communication terminal 103 of the photographer/videographer (step S1407) after the correct data update process (step S406). The communication terminal 103 of the photographer/videographer uses the image feature data and the correct data unique to the photographer/videographer to generate a learning model unique to the photographer/videographer (step S1408).

Thus, each of the communication terminals 103 of the photographers/videographers predicts the ease of selling by the learning model unique to the photographer/videographer every time the image data IMi is newly acquired (step S1303). As a result, the photographer/videographer can predict the ease of selling using a learning model customized for the image data IMi captured by said photographer/videographer, and it is possible to upload efficiently the image data anticipated to be sold, to the server 101 from the communication terminal 103 of the photographer/videographer.

In Embodiment 3, an example was described in which the communication terminal 103 of the photographer/videographer generates a learning model, but alternatively, the imaging device 102 of the photographer/videographer may generate the learning model.

As described above, according to the present embodiment, it is possible to learn the ease of selling the image data IMi according to past image feature data, and to predict the image data IMi using the learning model prior to sale thereof. Thus, as a result of the photographer/videographer uploading to the server 101 the image data IMi predicted to be easy to sell, it is possible to increase efficiency for expanding revenue.

By calculating the subject score for the image data IMi, the photographer/videographer can objectively extract the factors that make the image data IMi popular, namely whether the factors are the size of the subject, the pose of the subject, how in focus the subject is, or the conspicuity of a subject among multiple subjects. Thus, the photographer/videographer can ascertain in advance the method for capturing the subject to allow for a top-rank image on the sale page 1000, enabling an improvement in photography/videography skill.

If imaging data (e.g., at least one among the face detection information 504, the body frame information 505, the depth information 506, the focus information 507, and the exposure control information 508 in the image feature data table 500) is used as the image feature data, then the learning model may be generated using an explicable neural network. In this case, the learning model outputs the degree of importance for each piece of imaging data together with the selling ease score 1106 for the image data IMi. The degree of importance is fed back to the communication terminal 103 of the photographer/videographer. Thus, the photographer/videographer can refer to the degree of importance of each piece of imaging data to ascertain which piece of imaging data contributed to a given selling ease score 1106.

The value of the selling ease score 1106 being high is the result of the contribution of a piece of imaging data with a relatively high degree of importance, for example, and thus, it is possible to prompt a photographer to continue taking photographs in consideration of such imaging data. The value of the selling ease score 1106 being low is the result of the contribution of a piece of imaging data with a relatively high degree of importance, and thus, it is possible to prompt the photographer to improve their photography skill in consideration of such imaging data.

The present invention is not limited to the content above, and the content above may be freely combined. Also, other aspects considered to be within the scope of the technical concept of the present invention are included in the scope of the present invention.

### DESCRIPTION OF REFERENCE CHARACTERS

100 analysis system
101 server
102 imaging device
103 communication terminal of photographer/videographer
104 communication terminal of user
500 image feature data table
600 subject score table
900 sale page information table
1000 sale page
1100 correct data management table

1. A learning apparatus, comprising:
a processor that executes a program; and
a storage device that stores the program,
wherein the processor is configured to execute:
an acquisition process of acquiring an image data group, and correct data pertaining to sale of each piece of image data in the image data group; and
a generation process of generating a learning model that predicts an ease of selling the image data on the basis of the image data group and the correct data acquired during the acquisition process.

2. The learning apparatus according to claim 1,
wherein the correct data is correct data pertaining to a purchase count of the image data.

3. The learning apparatus according to claim 1,
wherein the correct data is correct data pertaining to view information of the image data.

4. The learning apparatus according to claim 3,
wherein the view information is a view count and/or a view time of the image data.

5. The learning apparatus according to claim 1,
wherein the learning model is generated using information pertaining to a subject in the image data.

6. The learning apparatus according to claim 5,
wherein the information pertaining to the subject is a position, a pose, and/or a defocus amount of the subject in the image data.

7. The learning apparatus according to claim 5,
wherein the information pertaining to the subject is a size of the subject in the image data and a size of another subject and/or a size of a background.

8. The learning apparatus according to claim 1,
wherein the learning model is generated using image feature data of the image data when the image data was captured.

9. The learning apparatus according to claim 1,
wherein the processor is configured to execute a prediction process of inputting to-be-predicted image data to the learning model, thereby generating a score indicating the ease of selling the to-be-predicted image data.

10. The learning apparatus according to claim 9,
wherein the processor is configured to execute relearning of the learning model on the basis of the correct data and the image data to which a score indicating the ease of selling with a value exceeding a prescribed threshold is applied, among the image data to which the scores are applied.

11. The learning apparatus according to claim 9,
wherein the processor is configured to display the image data to which the scores were applied in order of the score, or displays the image data to which the score having a value exceeding a prescribed threshold, among the image data to which the scores were applied, at a higher rank than the image data with the score at or below the prescribed threshold.

12. A learning apparatus, comprising:
a processor that executes a program; and
a storage device that stores the program,
wherein the processor is configured to execute:
an acquisition process of acquiring correct data pertaining to sale of an image data group from a server as a result of transmitting the image data group to the server; and
a generation process of generating a learning model that predicts an ease of selling the image data on the basis of the image data group and the correct data acquired during the acquisition process.

13. The learning apparatus according to claim 12,
wherein the processor is configured to execute a prediction process of inputting to-be-predicted image data to the learning model, thereby generating a score indicating the ease of selling the to-be-predicted image data.

14. A prediction apparatus, comprising:
a processor that executes a program; and
a storage device that stores the program,
wherein the processor is configured to execute:
an acquisition process of acquiring to-be-predicted image data; and
a prediction process of inputting the to-be-predicted image data acquired during the acquisition process to a learning model that predicts an ease of selling image data, thereby generating a score indicating the ease of selling the to-be-predicted image data.

15. A prediction apparatus, comprising:
a processor that executes a program; and
a storage device that stores the program,
wherein the processor is configured to execute:
an acquisition process of acquiring a learning model that predicts an ease of selling the image data; and
a prediction process of inputting to-be-predicted image data to the learning model acquired by the acquisition process, thereby generating a score indicating the ease of selling the to-be-predicted image data.

16. The prediction apparatus according to claim 15,
wherein the processor is configured to execute:
a determination process of determining whether to transmit the to-be-predicted image data on the basis of the score generated by the prediction process; and
a transmission process of transmitting the be-predicted image data on the basis of a determination result by the determination process.

17. An imaging apparatus, comprising:
the prediction apparatus according to claim 14; and
an imaging unit that captures a subject,
wherein image data of a subject captured by the imaging unit is inputted to the learning model.
